(19) United States
(12) Patent Application Publication
(10) Pub. No.: US 2025/0392523 A1
(43) Pub. Date: Dec. 25, 2025

(54) ARTIFICIAL INTELLIGENCE AND MACHINE LEARNING MODELS MANAGEMENT AND/OR TRAINING

(71) Applicant: Samsung Electronics Co., Ltd., Suwon-si, Gyeonggi-do (KR)

(72) Inventors: David Gutierrez ESTEVEZ, Chertsey (GB); Chadi KHIRALLAH, Chertsey (GB); Mahmoud WATFA, Chertsey (GB)

(21) Appl. No.: 18/879,177

(22) PCT Filed: Jul. 6, 2023
(86) PCT No.: PCT/KR2023/009593

§ 371 Date: Dec. 26, 2024

(30) Foreign Application Priority Data
Jul. 6, 2022 (GB) 2209942.8
Jun. 9, 2023 (GB) 2308682.0

(51) Int. Cl. H04L 41/16; H04W 76/27

(52) U.S. Cl. CPC H04L 41/16; H04W 76/27

(57) ABSTRACT

The disclosure relates to a 5G or 6G communication system for supporting a higher data transmission rate. A UE transmits information on at least one first artificial intelligence (AI)/machine learning (ML) model, wherein the information on the at least one first AI/ML model includes a list of AI/ML models, and wherein an AI/ML model included in the list of AI/ML models is identified by a first AI/ML model identifier (ID), receives at least one AI/ML model information indicating at least one AI/ML model to be activated, wherein the at least one AI/ML model to be activated is identified by a second AI/ML model ID; and activates the indicated at least one AI/ML model based on the received at least one AI/ML model information.

### TECHNICAL FIELD

Certain examples of the present disclosure provide one or more techniques for Artificial Intelligence (AI) and/or Machine Leaning (ML) models management and/or training. For example, certain examples of the present disclosure provide methods, apparatus and systems for Radio Access Network (RAN) AI and/or ML models management and/or training in a 3^{rd} Generation Partnership Project (3GPP) 5^{th} Generation (5G) network.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Herein, the following documents are referenced:
[1] RP-213599, Study on Artificial Intelligence (AI)/Machine Learning (ML) for NR Air Interface.
[2] 3GPP TS 38.413 v17.1.1, Technical Specification Group Radio Access Network; NG-RAN; NG Application Protocol (NGAP) (Release 17)
[3] 3GPP TS 38.331 v17.0.0, Technical Specification Group Radio Access Network; NR; Radio Resource Control (RRC) protocol specification (Release 17)
[4] 3GPP TS 38.423 v17.1.0, Technical Specification Group Radio Access Network; NG-RAN; Xn application protocol (XnAP) (Release 17)
[5] 3GPP TS 36.423 v17.1.0, Technical Specification Group Radio Access Network; Evolved Universal Terrestrial Radio Access Network (E-UTRAN); X2 application protocol (X2AP) (Release 17)
[6] 3GPP TS 23.501 v18.0.0
[7] 3GPP, Network Data Analytics Service (NWDAF)

### DISCLOSURE OF INVENTION

### Solution to Problem

The present application provides a method performed by a user equipment (UE), which includes following. A UE transmits information on at least one first artificial intelligence (AI)/machine learning (ML) model, wherein the information on the at least one first AI/ML model includes a list of AI/ML models, and wherein an AI/ML model included in the list of AI/ML models is identified by a first AI/ML model identifier (ID), receives at least one AI/ML model information indicating at least one AI/ML model to be activated, wherein the at least one AI/ML model to be activated is identified by a second AI/ML model ID; and activates the indicated at least one AI/ML model based on the received at least one AI/ML model information.

### BRIEF DESCRIPTION OF DRAWINGS

FIG. 1 illustrates an example of new radio-radio access network (NG-RAN) handling of AI/ML models (e.g. configuration, notification, activation, de-activation, other) depending on UE profiles (e.g. UE Profile #1 {UE Type=Vehicular, UE RRC State=Connected}, UE Profile #2 {UE Type=UAV, UE RRC State=Connected}, UE Profile #3 {UE Type=NTN, UE RRC State=Connected, UE Spatial-Temporal=Outdoor}, UE Profile #4 {UE Type=NTN, UE RRC State=Idle/Inactive, UE Spatial-Temporal=Indoor});

FIG. 2 illustrates an example of including “Assistance Information on AI/ML models IE” and “Configured AI/ML models IE” in INITIAL CONEXT SETUP REQUEST and RESPONSE messages, respectively;

FIG. 3 illustrates an example of including “Assistance Information on AI/ML models IE” and “Configured AI/ML models IE” in UE CONTEXT MODIFICATION REQUEST and RESPONSE messages, respectively;

FIG. 4 illustrates an example of activation of an AI/ML model X that is located at a UE, NG-RAN, an internal and/or external network entity, or split over several network entities (e.g. split over UE and NG-RAN);

FIG. 5 illustrates an example of including information on “NG-RAN supported AI/ML models” and “AMF supported AI/ML models” in NG SETUP REQUEST MESSAGE and NG SETUP RESPONSE message, respectively;

FIG. 6 illustrates an example of providing assistance information on AI/ML models to UE (including download of AI/ML models) via NG-RAN, 5CN, other network entity, network function, external entity, and/or OAM; and

FIG. 7 is a block diagram of an exemplary network entity that may be used in certain examples of the present disclosure.

### MODE FOR THE INVENTION

Various acronyms, abbreviations and definitions used in the present disclosure are defined at the end of this description.

AI/ML is being used in a range of application domains across industry sectors. In mobile communications systems, conventional algorithms (e.g. speech recognition, image recognition, video processing) in mobile devices (e.g. smartphones, automotive, robots) are being increasingly replaced with AI/ML models to enable various applications.

The 5^{th} Generation (5G) system can support various types of AI/ML operations, in including the following three defined in 3GPP TS 22.261 v18.6.1:

### AI/ML Operation Splitting Between AI/ML Endpoints

The AI/ML operation/model may be split into multiple parts, for example according to the current task and environment. The intention is to offload the computation-intensive, energy-intensive parts to network endpoints, and to leave the privacy-sensitive and delay-sensitive parts at the end device. The device executes the operation/model up to a specific part/layer and then sends the intermediate data to the network endpoint. The network endpoint executes the remaining parts/layers and feeds the inference results back to the device.

### AI/ML Model/Data Distribution and Sharing Over 5G System

Multi-functional mobile terminals may need to switch an AI/ML model, for example in response to task and environment variations. An assumption of adaptive model selection is that the models to be selected are available for the mobile device. However, since AI/ML models are becoming increasingly diverse, and with the limited storage resource in a UE, not all candidate AI/ML models may be pre-loaded on-board. Online model distribution (i.e. new model downloading) may be needed, in which an AI/ML model can be distributed from a Network (NW) endpoint to the devices when they need it to adapt to the changed AI/ML tasks and environments. For this purpose, the model performance at the UE may need to be monitored constantly.

### Distributed/Federated Learning over 5G System

A cloud server may train a global model by aggregating local models partially-trained by each of a number of end devices e.g. UEs). Within each training iteration, a UE performs the training based on a model downloaded from the AI server using local training data. Then the UE reports the interim training results to the cloud server, for example via 5G UL channels. The server aggregates the interim training results from the UEs and updates the global model. The updated global model is then distributed back to the UEs and the UEs can perform the training for the next iteration.

There is an ongoing study in 3GPP RAN groups on the topic of AI/ML where the objectives of the “Study on Artificial Intelligence (AI)/Machine Learning (ML) for NR Air Interface” [1] are as follows:

Study the 3GPP framework for AI/ML for air-interface corresponding to each target use case regarding aspects such as performance, complexity, and potential specification impact.

Use cases to focus on:
Initial set of use cases includes:
Channel State Information (CSI) feedback enhancement, e.g., overhead reduction, improved accuracy, prediction [RAN1]
Beam management, e.g., beam prediction in time, and/or spatial domain for overhead and latency reduction, beam selection accuracy improvement [RAN1]
Positioning accuracy enhancements for different scenarios including, e.g., those with heavy Non-Line-of-Sight (NLOS) conditions [RAN1]
Finalize representative sub use cases for each use case for characterization and baseline performance evaluations by RAN #98
The AI/ML approaches for the selected sub use cases need to be diverse enough to support various requirements on the gNB-UE collaboration levels

AI/ML model, terminology and description to identify common and specific characteristics for framework investigations:
Characterize the defining stages of AI/ML related algorithms and associated complexity:
Model generation, e.g., model training (including input/output, pre-/post-process, online/offline as applicable), model validation, model testing, as applicable
Inference operation, e.g., input/output, pre-/post-process, as applicable
Identify various levels of collaboration between UE and gNB pertinent to the selected use cases, e.g.,
No collaboration: implementation-based only AI/ML algorithms without information exchange [for comparison purposes]
Various levels of UE/gNB collaboration targeting at separate or joint ML operation.
Characterize lifecycle management of AI/ML model: e.g., model training, model deployment, model inference, model monitoring, model updating
Dataset(s) for training, validation, testing, and inference
Identify common notation and terminology for AI/ML related functions, procedures and interfaces
Protocol aspects, e.g., (RAN2)—RAN2 only starts the work after there is sufficient progress on the use case study in RAN1
Consider aspects related to, e.g., capability indication, configuration and control procedures (training/inference), and management of data and AI/ML model, per RAN1 input
Collaboration level specific specification impact per use case

Note 1: specific AI/ML models are not expected to be specified and are left to implementation. User data privacy needs to be preserved.

Note 2: The study on AI/ML for air interface is based on the current RAN architecture and new interfaces shall not be introduced.

What is desired is one or more techniques for Artificial Intelligence (AI) and/or Machine Leaning (ML) models management and/or training.

The above information is presented as background information only to assist with an understanding of the present disclosure. No determination has been made, and no assertion is made, as to whether any of the above might be applicable as prior art with regard to the present invention.

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

Certain examples of the present disclosure provide one or more techniques for Artificial Intelligence (AI) and/or Machine Leaning (ML) models management. For example, certain examples of the present disclosure provide methods, apparatus and systems for Radio Access Network (RAN) AI and/or ML models management in a 3^{rd} Generation Partnership Project (3GPP) 5^{th} Generation (5G) network. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The following examples are applicable to, and use terminology associated with, 3GPP 5G. However, as noted above the skilled person will appreciate that the techniques disclosed herein are not limited to 3GPP 5G. For example, the functionality of the various network entities and other features disclosed herein may be applied to corresponding or equivalent entities or features in other communication systems or standards. Corresponding or equivalent entities or features may be regarded as entities or features that perform the same or similar role, function or purpose within the network. For example, the functionality of the Access and Mobility management Function (AMF), Session Management Function (SMF), Network Data Analytics Function (NWDAF) and/or AI/ML Network Function (NF) in the examples below may be applied to any other suitable types of entities respectively providing an access and mobility function, a session management function, network analytics and/or an AI/ML function.

The skilled person will appreciate that the present invention is not limited to the specific examples disclosed herein. For example:
One or more entities in the examples disclosed herein may be replaced with one or more alternative entities performing equivalent or corresponding functions, processes or operations.
One or more of the messages in the examples disclosed herein may be replaced with one or more alternative types or forms of messages, signals or other type of information carriers that communicate equivalent or corresponding information.
One or more further entities and/or messages may be added to the examples disclosed herein.
One or more non-essential entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

A particular network entity may be implemented as a network element on a dedicated hardware, as a software instance running on a dedicated hardware, and/or as a virtualised function instantiated on an appropriate platform, e.g. on a cloud infrastructure.

In the present disclosure, a UE may refer to one or both of Mobile Termination (MT) and Terminal Equipment (TE). MT may offer common mobile network functions, for example one or more of radio transmission and handover, speech encoding and decoding, error detection and correction, signalling and access to a Subscriber Identity Module (SIM). An International Mobile Equipment Identity (IMEI) code, or any other suitable type of identity, may attached to the MT. TE may offer any suitable services to the user via MT functions. However, it may not contain any network functions itself.

AI/ML Application may be part of TE using the services offered by MT in order to support AI/ML operation, whereas AI/ML Application Client may be part of MT. Alternatively, part of AI/ML Application client may be in TE and a part of AI/ML application client may be in MT.

The procedures disclosed herein may refer to various network functions/entities. Various functions and definitions of certain network functions/entities, for example those indicated below, may be known to the skilled person, and are defined, for example, in at least 3GPP No. 23,501 v17.5.0 and 3GPP TS 23.502 v17.5.0:
Application Function: AF
Network Exposure Function: NEF
Unified Data Management: UDM
Unified Data Repository: UDR
Network Function: NF
Access and Mobility Function: AMF
Session Management Function: SMF
Network Data Analytics Function: NWDAF
(Radio) Access Network: (R)AN
User Equipment: UE

However, as noted above, the skilled person will appreciate that the present disclosure is not limited to the definitions given in 3GPP 23,501 v17.5.0 and 3GPP TS 23.502 v17.5.0, and that equivalent functions/entities may be used.

As noted above, what is desired is one or more techniques for AI and/or ML models management and/or training.

For example, certain examples of the present disclosure address one or more of the following questions:
Q1. How can the UE inform the network (e.g. RAN and/or Core Network (CN)) which AI/ML model(s): (i) the UE can handle/support, (ii) the UE stores (e.g. are preconfigured), and/or (iii) the UE is requesting for download?
Q2. How can the network provide to the UE a list of AI/ML models and/or other information related to those models (e.g. model(s) validity time and/or location)?
Q3. How to exchange AI/ML models and/or information/assistance information on AI/ML models among network entities?
Q4. How to activate, de-activate and/or switch AI/ML models (e.g. activate training, inference, etc.) at the UE and/or the network (e.g. NG-RAN and/or different network internal and/or external entities)?
Q5. How to manage model training and/or share training information between the UE and the network (e.g. RAN, CN, another internal and/or external network entity, and/or network function)?

Management of UE AI/ML Models: Sections 1-6 below disclose one or more techniques for addressing questions Q1-Q4 above.

Model training at UE and/or Network: Section 7 below discloses one or more techniques for addressing question Q5 above.

Certain examples of the present disclosure provide a method, for a User Equipment (UE), for Artificial Intelligence (AI)/Machine Learning (ML) model management in a network, the method comprising: transmitting, to the network, model identification information identifying one or more requested and/or supported AI/ML models for use at the UE.

In certain examples, the model identification information may comprise an AI/ML Model ID and/or related Use Case of a requested and/or supported AI/ML model.

In certain examples, the AI/ML models may be requested and/or supported by the UE for one or more of: download by the UE; activation by the UE; deactivation by the UE; switching by the UE; training by the UE; monitoring by the UE; selection by the UE; and identification by the UE.

In certain examples, the requested and/or supported AI/ML models may comprise a UE-sided model deployed on the UE side, and/or a two-sided model deployed on the UE side and the network side (e.g. RAN, CN, Operations, Administration and Maintenance (OAM), external entity, server, other).

In certain examples, the method may further comprise transmitting, to the network, information identifying a model operation type (e.g. training, inference, monitoring and/or other operation(s) deployed at the UE-side and/or network-side) of a requested and/or supported AI/ML model.

In certain examples, the method may further comprise transmitting, to the network, information indicating supported models at the UE (e.g. AI/ML Model ID and/or related Use Case).

In certain examples, the method may further comprise transmitting, to the network, information indicating models stored and/or available at the UE (e.g. AI/ML Model ID and/or related Use Case).

In certain examples, the method may further comprise transmitting, to the network, information indicating new and/or updated models (e.g. requested, supported and/or available) at the UE, and/or model related information (e.g. model ID, use case, model operation (e.g. training, inference and/or monitoring) and/or model distribution (e.g. model is at UE-side, network-side, OAM and/or server)).

In certain examples, the information may be transmitted in a Non Access Stratum (NAS) message (e.g. Registration Request message) sent to a Core Network (CN).

In certain examples, the information may be transmitted using Radio Resource Control (RRC) signalling and/or message(s) to a Radio Access Network (RAN) entity.

In certain examples, the method may further comprise receiving and/or downloading, by the UE, one or more of the requested and/or supported AI/ML models.

In certain examples, the AI/ML models may be received in NAS signalling and/or RRC signalling.

In certain examples, the AI/ML models may be received/downloaded from a network entity (e.g. RAN, CN, AMF, OAM, external entity, server, other).

In certain examples, the AI/ML models may be downloaded in response to a trigger and/or initiation from the network.

In certain examples, the downloaded AI/ML models may be selected by the network.

In certain examples, the method may further comprise performing, by the UE, one or more of the following operations in relation to one or more of the requested, supported, stored and/or available AI/ML models (e.g. for model training, inference and/or monitoring at the UE): selecting; activating; deactivating; and switching.

In certain examples, the operations in relation to the AI/ML models may be performed in response to signalling, a trigger and/or initiation from the network.

In certain examples, the AI/ML models for which the operations are performed may be selected by the network.

In certain examples, the AI/ML models for which the operations are performed may be identified by AI/ML Model IDs.

In certain examples, the method may further comprise receiving, from the network (e.g. RAN, CN, OAM, external entity, server, other), AI/ML model information on one or more AI/ML models.

In certain examples, the AI/ML model information may comprise one or more AI/ML model IDs.

In certain examples, the AI/ML model information may be received using RRC signalling and/or system information broadcast.

In certain examples, the UE may be in RRC connected mode.

In certain examples, the network may be a 3GPP 5G network.

Certain examples of the present disclosure provide a method, for a network, for Artificial Intelligence (AI)/Machine Learning (ML) model management, the method comprising: receiving, from a User Equipment (UE), model identification information identifying one or more requested and/or supported AI/ML models for use at the UE.

In certain examples, the method may further comprise triggering, by the network, activation, deactivation and/or switching of a combined or joint AI/ML model at two or more network entities (e.g. the UE and/or other network entities).

In certain examples, the method may further comprise exchanging information related to one or more models (e.g. list of models; supported, available and/or requested models; parameters related to models; and/or model management information) between network nodes (e.g. between RAN nodes, between RAN node and AMF, over Xn/X2 interface and/or over NG interface).

In certain examples, the method may further comprise providing, by a network entity (e.g. AMF), information related to one or more models (e.g. list of models; requested, supported, stored and/or available models; and/or rejected models) based on the information received from the UE.

In certain examples, the method may further comprise: updating, by a network entity (e.g. AMF), one or more allocated models previously sent to the UE and/or a network entity (e.g. RAN entity); and transmitting the updated models to the UE (e.g. directly in a NAS message, or via a RAN entity in an RRC message).

In certain examples, the method may further comprise defining a UE profile based on one or more of: UE RRC state, NAS mode, UE type, UE Spatial-Temporal state, UE Use Case, and UE Service.

In certain examples, the method may further comprise: providing, by a first network entity (e.g. AMF) to a second network entity (e.g. a RAN entity), information identifying one or more models and/or parameters (e.g. allocated by the AMF and supported by the UE) from/using OAM.

In certain examples, the method may further comprise storing, by a network entity (e.g. a RAN entity), in a UE context, assistance information on AI/ML models and/or information related to AI/ML operation of the UE.

In certain examples, the method may further comprise using, by a network entity (e.g. a RAN entity), assistance information when handling AI/ML operation of a UE.

In certain examples, the method may further comprise informing, by a first network entity (e.g. a RAN entity), a second network entity (e.g. AMF) of models configured at a UE based on assistance information on models and/or a UE profile.

Certain examples of the present disclosure provide a User Equipment (UE) configured to perform a method according to any aspect, example, embodiment and/or claim disclosed herein.

Certain examples of the present disclosure provide a network (or wireless communication system) configured to perform a method according to any aspect, example, embodiment and/or claim disclosed herein.

Certain examples of the present disclosure provide a computer program comprising instructions which, when the program is executed by a computer or processor, cause the computer or processor to carry out a method according to any aspect, example, embodiment and/or claim disclosed herein.

Certain examples of the present disclosure provide a computer or processor-readable data carrier having stored thereon a computer program according to any aspect, example, embodiment and/or claim disclosed herein.

The skilled person will appreciate that the techniques disclosed herein may be applied in any suitable combination(s). For example, one or more techniques disclosed in any of the following sections may be combined with one or more techniques disclosed in any other section(s), unless they are incompatible. In addition, one or more techniques disclosed in any of the following sections may be combined with one or more techniques disclosed in the same section, unless they are incompatible. Furthermore, the techniques disclosed herein, whether disclosed in different sections or in the same section, may be applied in any suitable order.

### 1. UE Provides Assistance Information on AI/ML Models to Network

This section defines one or more techniques for addressing question Q1 above:
Q1. How can the UE inform the network (e.g. RAN and/or CN) which AI/ML model(s): (i) the UE can handle/supports, (ii) the UE stores (e.g. are preconfigured), and/or (iii) the UE is requesting for download?

For example, the following discloses one or more techniques for the UE to provide assistance information (e.g. lists of AI/ML models) on AI/ML models (e.g. stored/available at the UE and/or models requested and/or supported by the UE (for download or and/or activation)).
The UE may provide to the NW (e.g. NG-RAN, CN, or other NW entity) one or more items of the following information on UE stored and/or requested AI/ML models for use at the UE:
A list of UE stored AI/ML models (e.g. AI/ML Model ID, related Use Case/Service Index, AI/ML model operation (e.g. training, inference, or other operations deployed at UE-side and/or NG-RAN-side, CN-side, OAM, other)).
A list of UE supported AI/ML models (e.g. AI/ML Model ID, related Use Case/Service Index, AI/ML model operation (e.g. training, inference, or other operations deployed at UE-side and/or NG-RAN-side, CN-side, OAM, other)).
A list of UE requested AI/ML models (e.g. AI/ML Model ID, related Use Case/Service Index, AI/ML model operation (e.g. training, inference, or other operations deployed at UE-side and/or NG-RAN-side, CN-side, OAM, other)) to be downloaded/boarded from the network (e.g. NG-RAN, AMF, OAM and/or other entity).
Both lists of UE stored/available/supported and requested AI/ML models to the NW (e.g. NG-RAN, AMF, or other entity).
For example:
UE may include the list of requested (and/or stored/available and/or supported) AI/ML models in the NAS Registration Request message sent to 5GC).
The UE may include a new/updated list of requested (and/or supported and/or available) AI/ML message. In certain examples this may trigger a registration procedure and the UE may then include this list in the Registration Request message as described above. For example, the UE may include an Information Element (IE) in the Registration Request message to indicate this list.
After model identification, the UE may report updates on applicable UE part/UE-side model(s). The applicable models may be a subset of all available models.
The UE may send to NG-RAN the list of requested (and/or available and/or supported) AI/ML models using existing RRC signalling/messages (e.g. RRCResumeComplete, RRCRestablishementComplete, RRCSetupComplete and/or any other suitable RRC message [3]), and/or newly defined RRC signalling/messages.
The UE may include the list of requested (and/or available and/or supported) AI/ML models (e.g. AI/ML Model ID, related Use Case/Service Index, AI/ML model operation (e.g. training, inference, or other operations deployed at UE-side and/or NG-RAN-side, CN-side, OAM, other)) as part of the UE capability indication. In certain examples, the UE may include an IE in the UE capability indication message to indicate these lists.
In certain examples, the UE may indicate the type of AI-ML category that it can support without the specific model. For example, the UE may indicate support of “Supervised learning”, “Unsupervised learning”, “Semi-supervised learning” Reinforcement Learning (RL)”, etc.
The UE in RRC connected mode may send the list of requested (and/or available and/or supported) AI/ML models, in addition to (or separate from) AI/ML data, included in the measurements report to NG-RAN.

### 2. Network Provides Assistance Information on AI/ML Models to UE

This section defines one or more techniques for addressing question Q2 above:
Q2. How can the network provide to the UE a list of AI/ML models and/or other information related to those models (e.g. model(s) validity time and/or location)?

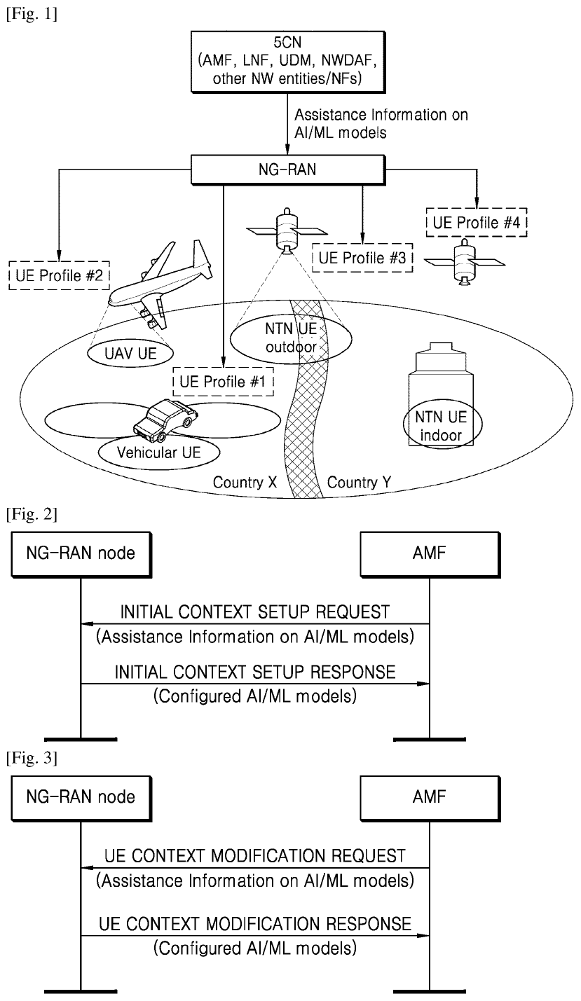

For example, the following discloses one or more techniques for the network to provide assistance information (e.g. lists of AI/ML models) on AI/ML models (e.g. allocated/allowed AI/ML models to be used/download/activated at the UE).
1. The CN (e.g. AMF, or another 5GC NF) may verify the available and/or requested lists or AI/ML models, provided by the UE, based on one or more of the following:
Subscriber information (e.g. retrieved from UDM). For example, the subscriber information may provide/include one or more of the following:
Generic permission for AI/ML RAN operation: this is a generic indication (generic permission) on whether the UE is allowed to perform AI/ML operations for RAN.
Per-AI/ML model permission: this is a specific indication(s) on whether the UE is allowed to use specific AI/ML model(s) for given use case(s)/service(s). For example, this may be for RAN AI/ML operation and/or any other NF AI/ML operation.
Other information related to AI/ML model(s) usage permission. For example, this may include permission validity in time and/or per location, UE may be allowed to use AI/ML model for positioning or mobility optimization in outdoor scenarios.
Other assistance information from the network (e.g. information/pre-dictions/statistics on UE mobility patterns, UE traffic patterns, UE behaviour, UE location, other information related to UE). For example, one or more of the following techniques may be used:
A NW entity (e.g. AMF and/or NG-RAN) may subscribe directly (or via another entity) to NWDAF analytics from the 5GC.
NW (e.g. AMF and/or NG-RAN) may use NWDAF analytics on UE mobility patterns and its knowledge of UE location (e.g. provided by Location Management Function (LMF) or directly from UE or via NG-RAN) to decide that at a given time the UE is expected to be in a given area/location and UE would need to use AI/ML model for accurate position calculation (e.g. calculation of UE location at a country border).
The network (e.g. AMF, SMF, User Plane Function (UPF), NG-RAN, other entities) may use NWDAF analytics/predictions on UE traffic patterns, UE velocity, and/or knowledge of available resources in NW entities (e.g. serving and/or neighbour NG-RANs) to decide that the UE may be expected to use AI/ML model for mobility optimization and/or AI/ML load balancing in order to perform optimum handover to a cell (or a slice) that can serve the UE's expected traffic load at a given time and/or location.
2. The AMF may provide a list of AI/ML models based on the UE requested AI/ML models (or part of the requested model(s)), a list of AI/ML models stored/available at the UE (e.g. AMF approves the list of AI/ML models stored at UE), and/or a list of rejected AI/ML models of stored and/or requested AI/ML models for the UE, or a list of mix of requested and available models, or a new set of AI/ML models based on use case(s)/service(s) and/or assistance information from NW (e.g. NWDAF analytics and predictions, subscription information).
3. The AMF may update the list of allocated AI/ML models, previously sent to UE and/or NG-RAN, at any time. For example, it may either send the updated list of AI/ML models directly in a NAS Message (e.g. Registration Accept or Configuration Update Command message), or send it to the RAN which sends to the UE in RRC message (e.g. RRC Reconfiguration message or any newly defined RRC message).
4. In addition to the list of AI/ML models provided in item 3 above, the AMF may provide assistance information (e.g. obtained from subscriber information and/or other entities in NW) to NG-RAN, that maps the use of each AI/ML model to/for a specific UE profile.
5. The UE profile may be defined, for example, based on one or more of: UE RRC state (e.g. RRC connected, Idle, or Inactive), NAS mode (e.g. 5GMM-CONNECTED mode, 5GMM-IDLE mode or 5GMM-CONNECTED mode with RRC inactive indication), UE type (e.g. Non-Terrestrial Network (NTN), Internet of Things (IoT), Unmanned Aerial Vehicle (UAV), Vehicular, RedCap, other), UE Spatial-Temporal state (e.g. UE presence at a given time or location, UE Outdoor/Indoor, UE altitude, etc.), UE Use Case, UE Service (e.g. Video Streaming). Any suitable combination of the previous states and/or types may be used.
The following is an example of a UE profile for a specific service and use case:
Use case=High Traffic Load, Service=Video Streaming, UE Spatial-Temporal State=(Indoor, Evening)
UE Profile {UE Type=Vehicular, UE RRC State=Connected, UE Use Case=High Traffic Load, UE Service=Video Streaming, UE Spatial-temporal=(Indoor, Evening), AI/ML Model=Mobility, Beam Management, Load Balancing}
FIG. 1 illustrates an example of NG-RAN handling of AI/ML models (e.g. configuration, notification, activation, de-activation, other) depending on UE profiles, for example as follows:
UE Profile #1 {UE Type=Vehicular, UE RRC State=Connected, AI/ML Model=Mobility, Beam Management, Load Balancing}
UE Profile #2 {UE Type=UAV, UE RRC State=Connected, AI/ML Model=Energy Saving}
UE Profile #3 {UE Type=NTN, UE RRC State=Connected, UE Spatial-Temporal=(Outdoor, time X), AI/ML Model=Positioning Accuracy}
UE Profile #4 {UE Type=NTN, UE RRC State=Idle/Inactive, UE Spatial-Temporal=(Indoor, Time Y), AI/ML Model=Energy Saving}.
6. The NG-RAN may store (or shall store, if supported) the received UE profile(s) in the UE context, and use the received UE profile(s) for management of AI/ML operations (e.g. activation, download, training, inference, other AI/ML operations) for the concerned UE.
The network (e.g. NG-RAN, AMF, other 5G Core Network (5CN) entity, or external entity) may share UE profile(s) with the UE and/or activate UE profile(s) at the UE depending on UE status (e.g. UE RRC status, other status as explained above). For example:
The NG-RAN may activate the UE profile at the UE by sending the entire UE profile to the UE (see FIG. 1).
In certain examples, the NG-RAN may label UE profiles, and then activate the suitable UE profile, at the UE, by sending the label of this UE profile to the UE, for example instead of sending the entire UE profile.
The NG-RAN may include the entire UE profile and/or the UE profile label, and/or any related information (e.g. activation command/instructions, other) in an existing RRC message (RRCReconfiguration, RRCRelease, RRCSetup, RRCReject, RRCReestablishement, RRCResume, other) or newly defined RRC message.
In certain examples, the UE may provide the network (e.g. NG-RAN, AMF, other 5CN entity, or external entity) information (and/or confirmation) on the currently used/selected/activated UE profile at the UE.
For example, this information can be shared with the NG-RAN using existing RRC signalling/messages (RRCReconfigurationComplete, RRCSetupComplete, RRCReestablishementComplete, RRCResumeComplete, ULInformationTransfer, UECapabilityInformation, UEAssistanceInformation, MeasurementReport, and/or other RRC signalling/messages [3]), and/or newly defined RRC signalling/messages.
7. The AMF may send the list(s) of allowed/allocated AI/ML models and other related information (e.g. UE profiles) to NG-RAN and/or UE (e.g. part of any NAS procedure/message such as the Registration accept message).
For example, the AMF may send the following information (e.g. in existing and/or newly defined IE) to NG-RAN and/or UE:
Assistance Information on AI/ML models IE={list of allowed/allocated AI/ML models, list of rejected/not permitted AI/ML models, list of UE profiles, mapping information between allowed/allocated AI/ML models and UE profiles, list of AI/ML model category (e.g. “Supervised learning”, “Unsupervised learning”, “Semi-supervised learning” Reinforcement Learning (RL)”, other), other information related to AI/ML operation at UE}.
8. The AMF may include the “Assistance Information on AI/ML models IE” in a suitably defined message, for example a newly defined message or any of the UE context management messages (defined in [2]).
Table 1 and FIGS. 2 and 3 disclose examples of including the “Assistance Information on AI/ML models IE” in the following messages:
INITIAL CONTEXT SETUP REQUEST message
UE CONTEXT MODIFICATION REQUEST message
9. In certain examples, the AMF may send to NG-RAN the “Assistance Information on AI/ML models” or any information related to AI/ML operation at/for the concerned UE, for example using any of the following messages (see Tables 4 and 5 below):
AMF Control Plane (CP) RELOCATION INDICATION message
UE INFORMATION TRANSFER message
HANDOVER REQUEST message
PATH SWITCH REQUEST ACKNOWLEDGE message
10. The AMF and NG-RAN may exchange the “Assistance Information on AI/ML models IE” and/or information related to this IE, as part of the UE Radio Capability Information [2].
INITIAL CONTEXT SETUP REQUEST message
CONNECTION ESTABLISHMENT INDICATION message
UE INFORMATION TRANSFER message
DOWNLINK NAS TRANSPORT message
UE RADIO CAPABILITY INFO INDICATION message
UE RADIO CAPABILITY CHECK REQUEST message
UE RADIO CAPABILITY ID MAPPING RESPONSE message
11. In certain examples, the AMF may inform the NG-RAN if the UE is capable of performing, or permitted to perform, AI/ML operations. Based on this information, the NG-RAN may directly obtain the list of relevant AI/ML models and parameters, allocated by AMF and supported by the UE, from another network central node or a newly defined Network entity or Network Function that may be dedicated to store, manage, and share AI/ML models to NG-RAN (or other NW entities and NFs) directly or via another NW entity. For example:
the newly defined entity maybe co-located in the 5GC with the MTLF (ML Training Logical Function) of NWDAF.
the newly defined entity in the 5GC model may enable federation of RAN and 5GC AI/ML models which have the same purpose (e.g. load balancing or mobility (handover) optimization).
12. In certain examples, the network (e.g. the AMF) may provide the NG-RAN with the list of relevant AI/ML models and parameters (e.g. allocated by the AMF and supported by the UE) from/using OAM.
13. In certain examples, the NG-RAN node shall, if supported, store the Assistance Information on AI/ML models IE, and/or any other information related to AI/ML operation of the concerned UE (e.g. UE AI/ML capability indication, lists of relevant AI/ML models and parameters, received from AMF or any other NW entity and/or NF) in the UE context.
14. The NG-RAN may use the Assistance Information on AI/ML models when handling AI/ML operation at the concerned UE (e.g. configuring, activating, deactivating, triggering training, or updating AI/ML model(s) at UE, or any other AI/ML related processes at the UE).
15. The NG-RAN may inform the AMF of AI/ML models configured at the UE based on “Assistance Information on AI/ML models” and UE profile. For example, NG-RAN node may include this information in an existing IE or a newly defined IE “Configured AI/ML models” as disclosed in FIGS. 2 and 3 and Table 2 below.

TABLE 1
Example of including “Assistance Information on AI/ML models
IE” in INITIAL CONTEXT SETUP REQUEST message.

| | | | | | | |
|---|---|---|---|---|---|---|
| | | | IE type | | | |
| IE/Group | | | and | Semantics | | Assigned |
| Name | Presence | Range | reference | description | Criticality | Criticality |

| | | | | | |
|---|---|---|---|---|---|
| Message | M | 9.3.1.1 | | YES | reject |
| Type | | | | | |
| AMF UE | M | 9.3.3.1 | | YES | reject |
| NGAP ID | | | | | |
| RAN UE | M | 9.3.3.2 | | YES | reject |
| NGAP ID | | | | | |
| [ . . . ] | | | | | |
| Assistance | O | 9.x.x.x.x | Indicates | YES | ignore |
| Information | | | the AI/ML | | |
| on AI/ML | | | models | | |
| models | | | permitted by | | |
| | | | the network | | |

TABLE 2
Example of including “Assistance Information on AI/ML models
IE” in INITIAL CONTEXT SETUP REQUEST message.

| | | | | | | |
|---|---|---|---|---|---|---|
| | | | IE type | | | |
| IE/Group | | | and | Semantics | | Assigned |
| Name | Presence | Range | reference | description | Criticality | Criticality |

| | | | | | |
|---|---|---|---|---|---|
| Message | M | 9.3.1.1 | | YES | reject |
| Type | | | | | |
| AMF UE | M | 9.3.3.1 | | YES | ignore |
| NGAP ID | | | | | |
| RAN UE | M | 9.3.3.2 | | YES | ignore |
| NGAP ID | | | | | |
| [ . . . ] | | | | | |
| Configured | O | 9.x.x.x.x | Indicates | YES | ignore |
| AI/ML | | | the AI/ML | | |
| models | | | models | | |
| | | | allowed by | | |
| | | | NG-RAN for | | |
| | | | the UE | | |

TABLE 3
Example of including “Assistance Information on AI/ML models
IE” in AMF CP RELOCATION INDICATION message.

| | | | | | | |
|---|---|---|---|---|---|---|
| | | | IE type | | | |
| IE/Group | | | and | Semantics | | Assigned |
| Name | Presence | Range | reference | description | Criticality | Criticality |

| | | | | | |
|---|---|---|---|---|---|
| Message | M | 9.3.1.1 | | YES | reject |
| Type | | | | | |
| AMF UE | M | 9.3.3.1 | | YES | reject |
| NGAP ID | | | | | |
| RAN UE | M | 9.3.3.2 | | YES | reject |
| NGAP ID | | | | | |
| S-NSSAI | O | 9.3.1.24 | | YES | ignore |
| Allowed | O | 9.3.1.31 | Indicates | YES | ignore |
| NSSAI | | | the S-NSSAIs | | |
| | | | permitted by | | |
| | | | the network | | |
| Assistance | O | 9.x.x.x.x | Indicates | YES | ignore |
| Information | | | the AI/ML | | |
| on AI/ML | | | models | | |
| models | | | permitted by | | |
| | | | the network | | |

TABLE 4
Example of including “Assistance Information on AI/ML
models IE” in UE INFORMATION TRANSFER message.

| | | | | | | |
|---|---|---|---|---|---|---|
| | | | IE type | | | |
| IE/Group | | | and | Semantics | | Assigned |
| Name | Presence | Range | reference | description | Criticality | Criticality |

| | | | | | |
|---|---|---|---|---|---|
| Message | M | 9.3.1.1 | | YES | reject |
| Type | | | | | |
| 5G S- | M | 9.3.3.20 | | YES | reject |
| TMSI | | | | | |
| NB-IoT | O | 9.3.1.145 | | YES | ignore |
| UE | | | | | |
| Priority | | | | | |
| UE Radio | O | 9.3.1.74 | | YES | ignore |
| Capability | | | | | |
| S-NSSAI | O | 9.3.1.24 | | YES | ignore |
| Allowed | O | 9.3.1.31 | Indicates | YES | ignore |
| NSSAI | | | the S-NSSAIs | | |
| | | | permitted by | | |
| | | | the network | | |
| [ . . . ] | | | | | |
| Assistance | O | 9.x.x.x.x | Indicates | YES | ignore |
| Information | | | the AI/ML | | |
| on AI/ML | | | models | | |
| models | | | permitted by | | |
| | | | the network | | |

### 3. NW Controlled Download of AI/ML Models Based on UE Profile

This section defines one or more techniques for addressing questions Q3 and Q4 above:
Q3. How to exchange AI/ML models and/or information/assistance information on AI/ML models among network entities?
Q4. How to activate, de-activate and/or switch AI/ML models (e.g. activate training, inference, etc.) at the UE and/or the network (e.g. NG-RAN and/or different network internal and/or external entities)?

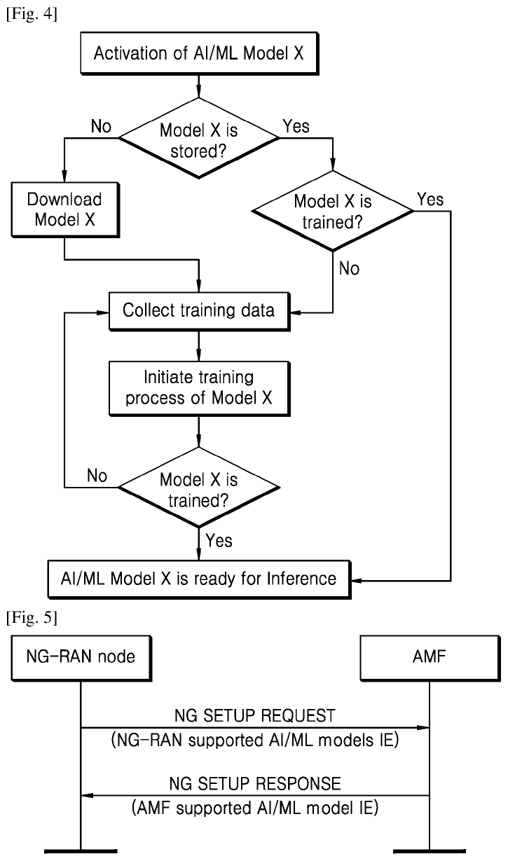

For example, the following discloses one or more techniques for the network to download and/or activate at least one AI/ML model in the UE.
1(a). The UE may request the downloading/boarding of AI/ML model(s). In certain examples, this may be done where the models requested were previously received by the UE, for example, as a list of allowed/allocated AI/ML models. These models may have been/may be received in any NAS signalling or RRC signalling from an existing NW entity, or from a newly defined or existing entity in the 5GC.
1(b). The UE may request activation or update of a stored AI/ML model(s) (e.g. for training, and/or inference).
2. The NG-RAN may allow the UE to (request to) download AI/ML model(s), or the NG-RAN may initiate/trigger the download of AI/ML model(s) to UE, and/or the NG-RAN may perform activation of downloaded (or stored) AI/ML model(s) (see FIG. 4), based on UE profile (see FIG. 1).
FIG. 4 discloses an example of activation of an AI/ML model X located at a UE, NG-RAN, an internal and/or external network entity, or split over several network entities (e.g. split over UE and NG-RAN).
In certain examples, AI/ML models may be downloaded from NG-RAN, other existing or newly defined NW entity, and/or via OAM.
3. The NG-RAN may behave according to one or more of the following:
Alt-1:
If NG-RAN receives the “Assistance Information on AI/ML models” from the AMF (or any other network entity), for example, included in any of UE context management messages and/or as part of the UE Radio Capability Information, the NG-RAN may behave as in item 2 above.
Alt-2:
If the NG-RAN did not receive the “Assistance Information on AI/ML models” from AMF (or any other network entity), the NG-RAN may retrieve this information from the UE, by sending an RRC message to retrieve this information.
In certain examples, the UE, after receiving an RRC message requesting AI/ML information from the RAN, should provide, in an RRC message, if available, the “Assistance Information on AI/ML models”, or list(s) of allocated, available, and/or supported AI/ML models at the UE.
Alt-3:
If the NG-RAN and the UE did not receive the “Assistance Information on AI/ML models”, or any part of this IE, from AMF, the NG-RAN may request UE to provide a list of its available, requested, and/or supported AI/ML models at/for this UE (e.g. based on UE AI/ML capability).
Then, NG-RAN may allow the UE to download AI/ML model(s), or NG-RAN may trigger download of AI/ML models to UE, and/or activation of downloaded (or stored) AI/ML model(s), taking into consideration NG-RAN's knowledge of the UE Profile and/or any other information related to UE (e.g. knowledge of UE battery charge, power consumption, processing capability, memory, storage, etc.) and/or NG-RAN (e.g. supported AI/ML models), and/or NG-RAN knowledge of required resources to perform the AI/ML operations related to this model at UE and/or NG-RAN.
Alt-4:
If the NG-RAN and the UE did not receive “Assistance Information on AI/ML models”, but the NG-RAN received (e.g. from AMF, or another NW entity) information that the UE is capable/permitted to perform AI/ML operations, the NG-RAN may obtain the Assistance Information on AI/ML models, or list of relevant AI/ML models and parameters assigned to concerned UE from (at least) another network entity.
Then, NG-RAN may select a suitable AI/ML model for UE based on UE profile. The NG-RAN may then indicate the selected AI/ML model to the UE for its use.
Alt-5:
If NG-RAN and UE did not receive “Assistance Information on AI/ML models”, and/or information that the UE is capable/permitted to perform AI/ML operations, NG-RAN may retrieve UE capability (from UE) to check for any information of UE capability to handle AI/ML operation and/or information of AI/ML models stored and/or supported by UE.
Then, NG-RAN may select a suitable AI/ML model for UE based on UE profile.
In certain examples, NG-RAN may forward any information related to the retrieved UE AI/ML Capability to AMF, for example, included in UE RADIO CAPABILITY INFO INDICATION message.
Alt-6: The NG-RAN may trigger (the activation and/or use of) AI/ML model(s) at the UE, based on an indication from the CN (AMF, LMF, or other NW entity, Application function) or OAM or local configuration.

### 4. AI/ML Model Management Over Xn/X2 Interface (Setup, Configuration Update, Handover)

This section defines one or more techniques for addressing question Q3 above:
Q3. How to exchange AI/ML models and/or information/assistance information on AI/ML models among network entities?
For example, the following discloses one or more techniques for the network to exchange AI/ML models and/or assistance information on AI/ML models among network entities.

### Xn Setup Procedure (Non UE Associated):

During Xn interface setup between NG-RAN nodes, the list of AI/ML models may be exchanged between the NG-RAN nodes.
In certain examples, NG-RAN nodes may exchange their supported (and/or available) AI/ML models (e.g. transfer all models, some models, full model(s), part of model(s), and/or parameters related to those models).
For example, the XN SETUP REQUEST message and XN SETUP RESPONSE message [4], may contain for each cell, served by NG-RAN 1 & 2, a list of AI/ML Models (supported by NG-RANs in different cells).
In certain examples, each NG-RAN will be aware of its neighbour's list of supported AI/ML models.

### NG-RAN Node Configuration Update Procedure (Non UE Associated):

During the NG-RAN node Configuration Update procedure, two NG-RAN nodes may exchange any updated lists of AI/ML models (in each cell) and/or updated AI/ML models. For example:
the network may update lists of supported AI/ML models, (i.e. models supported by NG-RAN, AMF, LMF, other network entities or NFs), following changes of regulations and policies in the network.
changes in countries policies and regulations on collecting and handling user data (e.g. location, trajectory, altitude, velocity, etc.), could mean that the network (service provider, or a third party) may no longer be permitted to use specific AI/ML model(s) that would allow them to obtain highly accurate and detailed user information, without obtaining a legal permission or user consent to handle their data.
In certain examples, if the List of supported AI/ML models (for example included in an existing IE or newly defined IE) is included in the NG-RAN NODE CONFIGURATION UPDATE message, the receiving NG-RAN shall replace the previously received List of supported AI/ML models by the updated List of supported AI/ML models.

The above techniques for Xn interface may be applied similarly to X2 interface, however, using suitable/corresponding network entities and X2 procedures and messages (e.g. as defined in [5]).

### 5. AI/ML Model Management Over NG Interface (Setup, Configuration Update, Handover)

This section defines one or more techniques for addressing question Q3 above:
Q3. How to exchange AI/ML models and/or information/assistance information on AI/ML models among network entities?
For example, the following discloses one or more techniques for the network to exchange AI/ML models and/or assistance information on AI/ML models among network entities. It should be noted the proposals apply in any order and/or combination.

### NG Setup Procedure:

During NG interface setup between NG-RAN and AMF, the list of supported AI/ML models may be exchanged between NG-RAN and AMF.
In certain examples, NG-RAN and AMF may exchange their supported (or available) AI/ML models (e.g. transfer all models, some models, full model(s), part of model(s), and/or parameters related to those models).
For example, information on “NG-RAN supported AI/ML models IE” (or Supported AI/ML model List IE, or any other IE naming) and “AMF supported AI/ML models IE” (or any other IE naming) may be included in NG SETUP REQUEST MESSAGE and NG SETUP RESPONSE message [2], respectively, as shown in FIG. 5.

### RAN Configuration Update:

NG-RAN node may send an updated list(s) of supported AI/ML models to AMF.
For example, this may be done using RAN CONFIGURATION UPDATE message [2], for example as shown in Table 5 below.
In certain examples, if the RAN CONFIGURATION UPDATE message includes the List of NG-RAN supported AI/ML models (included in an existing IE or newly defined IE), the AMF may store this list or update this IE value if already stored (or AMF shall overwrite any previously received value of this IE), and AMF shall consider that the NG-RAN supports the list of AI/ML models received in RAN CONFIGURATION UPDATE message.

AMF Configuration Update:
AMF node may send an updated list(s) of supported AI/ML models to NG-RAN.
For example, this may be done using AMF CONFIGURATION UPDATE message [2].
In certain examples, if the AMF CONFIGURATION UPDATE message includes the List of AMF supported AI/ML models (included in an existing IE or newly defined IE), the NG-RAN may store this list or update this IE value if already stored (or NG-RAN shall overwrite any previously received value of this IE), and NG-RAN shall consider that the AMF supports the list of AI/ML models received in AMF CONFIGURATION UPDATE message.

TABLE 5
Example of including information on “Supported AI/ML models/model
List IE” RAN CONFIGURATION UPDATE message.

| | | | IE type | | | |
|---|---|---|---|---|---|---|
| IE/Group | | | and | Semantics | | Assigned |
| Name | Presence | Range | reference | description | Criticality | Criticality |
| Message Type | M | | 9.3.1.1 | | YES | reject |
| RAN Node Name | O | | PrintableString(SIZE(1 | | YES | ignore |
| | | | . . . 150, . . . )) | | | |
| Supported TA | | 0 . . . 1 | | Supported | YES | reject |
| List | | | | TAs in the | | |
| | | | | NG-RAN | | |
| | | | | node. | | |
| [ . . . ] | | | | | | |
| Supported AI/ML | | 0 . . . 1 | | Supported | YES | reject |
| model List | | | | AI/ML | | |
| | | | | models in | | |
| | | | | the NG-RAN | | |
| | | | | node. | | |
| >Supported AI/ | | 1 . . . <maxnoofAI/ | | | | |
| ML model Item | | ML models> | | | | |
| >>AI/ML model | | | ENUMERATED | | | |
| deployment | | | (UE-side, | | | |
| | | | NG-RAN-side, | | | |
| | | | CN-side, | | | |
| | | | two-side, | | | |
| | | | multiple-side, | | | |
| | | | OAM, other, | | | |
| | | | . . . ) | | | |
| >>AI/ML model | | | ENUMERATED | | | |
| training | | | (UE-based, | | | |
| | | | NG-RAN-based, | | | |
| | | | CN-based, | | | |
| | | | two-side, | | | |
| | | | multiple-side, | | | |
| | | | OAM, other, | | | |
| | | | . . . ) | | | |
| >>AI/ML model | | | ENUMERATED | | | |
| training type | | | (online, | | | |
| | | | offline, other, | | | |
| | | | . . . ) | | | |
| >>AI/ML model | | | ENUMERATED | | | |
| inference | | | (UE-based, | | | |
| | | | NG-RAN-based, | | | |
| | | | CN-based, | | | |
| | | | two-side, | | | |
| | | | multiple-side, | | | |
| | | | OAM, other, | | | |
| | | | . . . ) | | | |
| >>AI/ML model | | | ENUMERATED | | | |
| update | | | (UE-side, | | | |
| | | | NG-RAN-side, | | | |
| | | | CN-side, | | | |
| | | | two-side, | | | |
| | | | multiple-side, | | | |
| | | | OAM, other, | | | |
| | | | . . . ) | | | |
| >>AI/ML model | | | ENUMERATED | | | |
| learning/training | | | (“Supervised | | | |
| category/class/ | | | learning”, | | | |
| algorithm | | | “Unsupervised | | | |
| | | | learning”, | | | |
| | | | “Semi-supervised | | | |
| | | | learning”, | | | |
| | | | “Reinforcement | | | |
| | | | Learning | | | |
| | | | (RL)”, other, | | | |
| | | | . . . ) | | | |
| >>AI/ML model | | | ENUMERATED | | | |
| transfer | | | (Full, Partial, | | | |
| | | | model Parameters, | | | |
| | | | other, . . . ) | | | |

### 6. Distribution of AI/ML Models to UE

This section defines one or more techniques for addressing question Q2 above:
Q2. How can the network provide to the UE a list of AI/ML models and/or other information related to those models (e.g. model(s) validity time and/or location)?

For example, the following discloses one or more techniques for the network to provide information on AI/ML models to the UE. It should be noted the proposals apply in any order and/or combination.

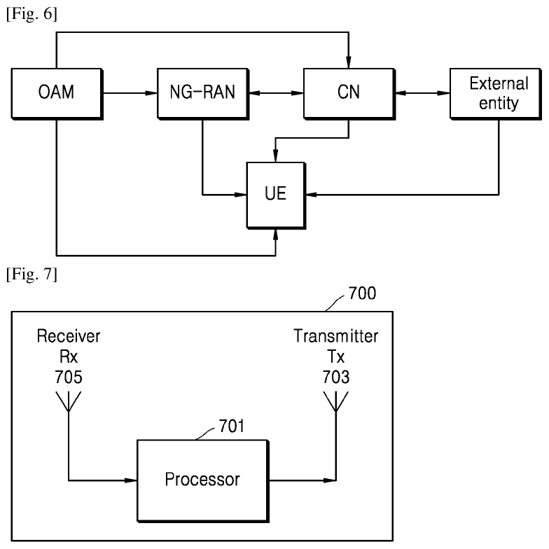

FIG. 6 illustrates an example of providing assistance information on AI/ML models to UE (including download of AI/ML models) via NG-RAN, 5CN, other network entity, network function, external entity, and/or OAM.

UE is Provided with a List of AI/ML models:
UE may be preconfigured with a list of AI/ML models via OAM.
UE may obtain the list of AI/ML models from NG-RAN, 5CN, other network entity (e.g. AMF), network function.
UE may obtain the list of AI/ML models from an external entity.
UE may store the list of AI/ML models (e.g. namely list of available/stored AI/ML models) and share with the networks. For example, UE may include the list of requested (or stored/available) AI/ML models in the NAS Registration Request message sent to 5GC).
In certain examples, in addition to the list of AI/ML models, the UE may also be provided with all or some of AI/ML model(s) of this list. For example, all or some of the AI/ML models may be preconfigured in the UE via OAM and another network entity.

The list of AI/ML models may contain one or more of the following:
AI/ML model ID
Information on Training and/or Inferences deployment side (e.g. UE and/or NG-RAN training side)
Information on whether the AI/ML model is split over UE, NG-RAN, and/or another network entity.
Information on AI/ML model task (e.g. CSI enhancement model, Beam management model, Positioning model, Energy Saving model, Load Balancing model, Resource management Model)
Traffic prediction Model, Mobility Model and/or Other Model
For example:
Positioning Model: used to estimate the location of a given UE at the desired positioning accuracy (e.g. for NTN UE it is important to decide UE location accurately, especially). The AI/ML model processing (e.g. training, inference, other tasks) may be split between the UE, NG-RAN, LMF, and/or other NW entities.
Mobility Model: used to optimize the UE mobility (e.g. to predict the best cell, and/or time to handover the UE in RRC CONNECTED state).

NG-RAN providing information on AI/ML model(s) to UE:
NG-RAN may provide the UE with information on supported/available AI/ML models, in a given serving cell and/or neighbouring cells (e.g. per TA, RA, Public Land Mobile Network (PLMN), country, other area) at a given time, for example using one or more of:
RRC signalling, for example:
RRC Reconfiguration (UE in RRC_CONNECTED state), and/or
RRC Release (on moving the UE to RRC_INACTIVE state)
System information broadcasted, for example:
Periodically, and/or
On-demand (e.g. using MSG1/MSG3)
For example, NG-RAN may provide the UE (e.g. via system information and/or RRC signalling/messages) one or more of the following items of information on AI/ML models:
Full or part of AI/ML model information
List of AI/ML Model(s) IDs/indices (1 [symbol] number of AI/ML models)
AI/ML Model Validity Area (e.g., Location, Cell, TA, Country, Area of Interest, other)
AI/ML Model Validity timer/time
AI/ML Model Management Information
Training (e.g. in OAM, NG-RAN, distributed, other)
Inference (e.g. in OAM, NG-RAN, distributed, other)
Processing (e.g., locally, distributed)
AI/ML Model training part of a Federated Learning
Synchronous (e.g. all UEs are periodically triggered to perform model training and reported to the network (NG-RAN, CN, other)
Asynchronous (based on a local criteria at UE or NW)
Other
Index of AI/ML model(s) available at NG-RAN.

AI/ML model(s) download, upload, updates, etc.:
UE may download/obtain its AI/ML model(s) (or updates of stored AI/ML models) from NG-RAN, 5CN, another network entity, external entity, and/or via OAM, for example as shown in FIG. 6.
NG-RAN may download/obtain AI/ML model(s) (or updates of stored AI/ML models) 5CN, another network entity, external entity, and/or via OAM, for example as shown in FIG. 6.
   7. Model Training at UE and/or Network

This section defines one or more techniques for addressing question Q5 above:
Q5. How to manage model training and/or share training information between the UE and the network (e.g. RAN, CN, another internal and/or external network entity, and/or network function)?

For example, the following discloses one or more techniques for the network and/or UE to manage AI/ML model training.

For example, the network may train the model(s) at a network entity (e.g. NG-RAN, other CN entity) and/or via OAM, then deploy trained model(s) (e.g. full model, or part of model, and/or parameters of trained model) to the UE and/or another network entity (e.g. NG-RAN).

The following lists examples of possible model training location at the UE, Network, and/or both (i.e. training is replicated or split over more than multiple entities):
Model training at the UE:
The UE may store and/or download the training model from network (and/or via OAM)
The network (e.g. NG-RAN and/or 5CN entity) may activate training of a given model at the UE
The network may initiate the model training, at the UE, for example following:
An indication from the UE to initiates model training:
Explicit indication using existing or a newly defined IE, and/or
Implicit indication following the network reception of AI/ML measurements/measurement reports/data from the UE, and/or
An indication from another network entity (e.g. AMF, LMF, other), based on assistance information (e.g. NWDAF analytics).
Model training at the Network:
The network (e.g. AMF, LMF) may activate model(s) training at another network entity (e.g. AMF activates models training at the NG-RAN).
After completion of model training (or during training process), the considered network entity (e.g. NG-RAN) may deploy the trained model (e.g. as a full model, part of the model and/or parameters of the trained model) at the UE and/or another network entity.
Combined/Joint Model training at the Network and UE (e.g. models are either split or replicated among/at UE and Network):
The network (e.g. NG-RAN, AMF, LMF, other) may activate model(s) training at another network entity and/or the UE.
For example, the NG-RAN may trigger activation of a given model, stored at the NG-RAN (itself) and the UE.
Models (e.g. split or replicated) at different entities (e.g. UE, NG-RAN, CN), may be trained, for example separately or jointly at different entities (e.g. UE, NG-RAN, CN).
The outcome of joint or separate training may be aggregated (e.g. fused, federated, other) and/or further modified at a designated entity.
The aggregated/combined training outcome is shared with other entities. For example, the outcome of separate model training in the UE and NG-RAN, may be aggregated, for example by NG-RAN, and sent to the UE.

FIG. 7 is a block diagram of an exemplary network entity that may be used in examples of the present disclosure, such as the techniques disclosed in relation to FIGS. 1 to 6. For example, an UE, AI/ML AF, NEF, UDM, UDR, NF, (R)AN, AMF, SMF, NWDAF and/or other NFs may be provided in the form of the network entity illustrated in FIG. 7. The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure.

The entity 700 comprises a processor (or controller) 701, a transmitter 703 and a receiver 705. The receiver 705 is configured for receiving one or more messages from one or more other network entities, for example as described above. The transmitter 703 is configured for transmitting one or more messages to one or more other network entities, for example as described above. The processor 701 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

An NG-RAN node is either a gNB, providing NR user plane and control plane protocol terminations towards the UE; or an ng-eNB, providing E-UTRA user plane and control plane protocol terminations towards the UE.

The gNBs and ng-eNBs are interconnected with each other by means of the Xn interface. The gNBs and ng-eNBs are also connected by means of the NG interfaces to the 5GC, more specifically to the AMF (Access and Mobility Management Function) by means of the NG-C interface and to the UPF (User Plane Function) by means of the NG-U interface.

While the invention has been shown and described with reference to certain examples, it will be understood by those skilled in the art that various changes in form and detail may be made therein without departing from the scope of the invention, as defined by the appended claims.

### ACRONYMS AND DEFINITIONS

3GPP 3^{rd} Generation Partnership Project
5CN 5G Core Network
5G 5^{th} Generation
5GC 5G Core
5GMM 5G Mobility Management
AF Application Function
AI Artificial Intelligence
AMF Access and Mobility management Function
CN Core Network
CP Control Plane
CSI Channel State Information
E-UTRAN Evolved Universal Terrestrial Radio Access Network
gNB NG Base Station
ID Identity/Identifier
IE Information Element
IMEI International Mobile Equipment Identities
IoT Internet of Things
LMF Location Management Function
ML Machine Learning
MSG1/MSG3 Random Access Preamble/Random Access Response messages
MT Mobile Termination
MTLF Model Training Logical Function
NAS Non-Access Stratum
NB Narrowband
NEF Network Exposure Function
NF Network Function
NG Next Generation
NG Interface between RAN and CN
NGAP Next Generation Application Protocol
NLOS Non-Line-of-Sight
NR New Radio
NSSAI Network Slice Selection Assistance Information
NTN Non-Terrestrial Network
NTU Network Termination Unit
NW Network
NWDAF Network Data Analytics Function
OAM Operations, Administration and Maintenance
PLMN Public Land Mobile Network
RA Roaming Area
(R)AN (Radio) Access Network
RL Reinforcement Learning
RRC Radio Resource Control
SIM Subscriber Identity Module
SMF Session Management Function
S-NSSAI Single NSSAI
TA Tracking Area
TE Terminal Equipment
TMSI Temporary Mobile Subscriber Identity
TS Technical Specification
UAV Unmanned Aerial Vehicle
UDM Unified Data Manager
UDR Unified Data Repository
UE User Equipment
UL Uplink
UPF User Plane Function
Xn/X2 Interface between RAN nodes

1. A method performed by a user equipment (UE), the method comprising:
transmitting information on at least one first artificial intelligence (AI)/machine learning (ML) model, wherein the information on the at least one first AI/ML model includes a list of AI/ML models, and wherein an AI/ML model included in the list of AI/ML models is identified by a first AI/ML model identifier (ID);
receiving at least one AI/ML model information indicating at least one AI/ML model to be activated, wherein the at least one AI/ML model to be activated is identified by a second AI/ML model ID; and
activating the indicated at least one AI/ML model based on the received at least one AI/ML model information.

2. The method of claim 1, further comprising:
receiving, from a base station, information on at least one second AI/ML model in radio resource control (RRC) signaling.

3. The method of claim 1, further comprising:
receiving, from a network entity, information on at least one second AI/ML model in non-access stratum (NAS) signaling.

4. The method of claim 1, wherein the list of AI/ML models includes at least one AI/ML model requested or supported by the UE.

5. The method of claim 1, wherein the UE is in an RRC connected state.

6. The method of claim 1, wherein the activating of the indicated at least one AI/ML model comprises:
activating at least one AI/ML model allowed by a base station.

7. A method performed by a base station, the method comprising:
receiving, from a user equipment (UE), information on at least one first artificial intelligence (AI)/machine learning (ML) model, wherein the information on the at least one first AI/ML model includes a list of AI/ML models, and wherein an AI/ML model included in the list of AI/ML models is identified by a first AI/ML model identifier (ID); and
transmitting, to the UE, at least one AI/ML model information indicating at least one AI/ML model to be activated, wherein the at least one AI/ML model to be activated is identified by a second AI/ML model ID,
wherein the indicated at least one AI/ML model is activated at the UE based on the transmitted at least one AI/ML model information.

8. A user equipment (UE) comprising:
a transceiver; and
at least one processor coupled with the transceiver and configured to:
transmit information on at least one first artificial intelligence (AI)/machine learning (ML) model, wherein the information on the at least one first AI/ML model includes a list of AI/ML models, and wherein an AI/ML model included in the list of AI/ML models is identified by a first AI/ML model identifier (ID),
receive at least one AI/ML model information indicating at least one AI/ML model to be activated, wherein the at least one AI/ML model to be activated is identified by a second AI/ML model ID, and
activate the indicated at least one AI/ML model based on the received at least one AI/ML model information.

9. The UE of claim 8, wherein the at least one processor is further configured to:
receive, from a base station, information on at least one second AI/ML model in radio resource control (RRC) signaling.

10. The UE of claim 8, wherein the at least one processor is further configured to:
receive, from a network entity, information on at least one second AI/ML model in non-access stratum (NAS) signaling.

11. The UE of claim 8, wherein the list of AI/ML models includes at least one AI/ML model requested or supported by the UE.

12. The UE of claim 8, wherein the UE is in an RRC connected state.

13. The UE of claim 8, wherein the at least one processor is configured to:
activate at least one AI/ML model allowed by a base station.

14. A base station comprising:
a transceiver; and
at least one processor coupled with the transceiver and configured to:
receive, from a user equipment (UE), information on at least one first artificial intelligence (AI)/machine learning (ML) model, wherein the information on the at least one first AI/ML model includes a list of AI/ML models, and wherein an AI/ML model included in the list of AI/ML models is identified by a first AI/ML model identifier (ID), and transmit, to the UE, at least one AI/ML model information indicating at least one AI/ML model to be activated, wherein the at least one AI/ML model to be activated is identified by a second AI/ML model ID, wherein the indicated at least one AI/ML model is activated at the UE based on the transmitted at least one AI/ML model information.
